(19) United States
(12) Patent Application Publication
(10) Pub. No.: US 2009/0037705 A1
(43) Pub. Date: Feb. 5, 2009

(54) Method and Device for Processing Data Words and/or Instructions

(76) Inventors: Eberhard Boehl, Reutlingen (DE); Reinhard Weiberle, Vaihingen/Enz (DE); Bernd Mueller, Gerlingen (DE); Yorck Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/990,249

(22) PCT Filed: Jul. 27, 2006
(86) PCT No.: PCT/EP2006/064719

§ 371 Date: Feb. 8, 2008

(51) Int. Cl. G06F 9/30

(52) U.S. Cl. 712/229; 712/E09.016

(57) ABSTRACT

A method for processing data words and/or instructions, a distinction being made, in the processing, between at least two operating modes, and a first operating mode corresponding to a compare mode and a second operating mode corresponding to a performance mode, in the compare mode, a comparator unit being activated and this comparator unit being deactivated in the performance mode, wherein the comparator unit is activated for the compare mode as a function of two equal data words and/or instructions getting to be processed and the at least equal data words and/or instructions in each case being distributed by a control unit to the at least two execution units.

### FIELD OF THE INVENTION

The present invention relates to a method and a device for distinguishing between at least two operating modes of a microprocessor having at least two execution units for executing program segments.

### BACKGROUND INFORMATION

Transient errors, triggered by alpha particles or cosmic radiation, are an increasing problem for integrated circuits. Due to declining structure widths, decreasing voltages and higher clock frequencies, there is an increased probability that a change in charge, caused by an alpha particle or by cosmic radiation, will corrupt a logic value in an integrated circuit. The effect may be a corrupted calculation result.

In safety-related systems, such errors must therefore be detected reliably. In safety-related systems, such as an ABS control system in a motor vehicle, in which malfunctions of the electronic equipment must be detected with certainty, redundancies are normally provided for error detection, particularly in the corresponding control devices of such systems. Thus, for example, in known ABS systems, the complete microcontroller is duplicated in each instance, all ABS functions being calculated redundantly and checked for consistency. If a discrepancy appears in the results, the ABS system is switched off.

Such processor units having at least two integrated cores are also known as dual-core architectures or multi-core architectures. The different cores execute the same program segment redundantly and in a clock-synchronized manner; the results of the two cores are compared, and an error will then be detected when the cores are compared for consistency. In the following, this configuration is called compare mode.

Dual-core or multi-core architectures are also used in other applications to increase output, i.e., for performance enhancement. The two cores execute different program segments, whereby an increase in output can be achieved, which is why this configuration is called performance mode. If the two cores are the same, this system is also called a symmetrical multiprocessor system (SMP).

These systems are extended in that software is used to switch between these two modes by accessing a special address and by specialized hardware devices. In the compare mode, the output signals of the cores are compared to each other. In the performance mode, the two cores operate as a symmetrical multiprocessor system (SMP) and execute different programs, program segments, or instructions.

### SUMMARY OF THE INVENTION

One advantage of the present invention is that no different processor modes have to be considered between which time-consuming switching over has to take place, depending on the architecture of the execution units.

It is an object of the present invention to achieve a flexibility between these different modes of operation of the two modes, and this, in particular without achieving an explicit switchover of the modes. Only the comparator unit is still to be activated or deactivated. This activation or deactivation is not to take place explicitly by an instruction or an instruction sequence, but only still implicitly.

An additional advantage is that one may do without explicit switchover instructions, since for this, otherwise, bits and bit combinations in the instruction word of the execution unit would have to be reserved.

Furthermore, it is advantageous that the possibilities exist, on the one hand, to be able to switch over, without low-level software, between compare mode and performance mode, and, on the other hand, to allow the comparison to be carried out also just for individual instructions, instead of switching over the entire processor in mode.

It is also an advantage that the parallel execution units are able to work at a fixed clock pulse offset, and that, because of this, in particular in compare mode, the influence of globally acting error events of short duration, on the data to be compared, is reduced.

The comparator unit is advantageously activated for the compare mode as a function of two equal data words and/or instructions being processed, and the at least equal data words and/or instructions in each case being distributed by a control unit to the at least two execution units. The data words and/or instructions advantageously come to be processed synchronously or at a fixed clock pulse offset. The data words and/or the instructions are expediently included in one instruction word as partial data words and/or partial instructions. The data words and/or instructions are advantageously situated one after the other in the program run. Depending on the number of equal successive data words and/or instructions, these are advantageously distributed to a corresponding number of execution units. The comparator unit is expediently deactivated if two consecutive data words and/or instructions, which would be executed in the at least two execution units simultaneously or at the same clock pulse offset with respect to each other, are not consistent. The data and instructions that are to be compared are advantageously specified by a specifiable position in the memory. A device for processing data words and/or instructions is advantageously included, a distinction being made in the processing between at least two operating modes, and a first operating mode corresponds to a compare mode, and a second operating mode to a performance mode, having a comparator unit which is designed in such a way that it is activated in the compare mode and deactivated in the performance mode, wherein means are included that are developed so that the compare unit is then activated for the compare mode as a function of whether at least two equal data words and/or instructions are successively processed and the at least two equal data words and/or instructions are distributed to the at least two execution units respectively.

### BRIEF DESCRIPTION OF THE DRAWINGS

FIG. 1 shows the schematic construction of a superscalar computer.

FIG. 2 shows one possibility for implementing the construction of a decoding unit C220 from C200 for a superscalar execution unit not having a VLIW architecture.

FIG. 3 shows a possible implementation of the decoding unit C220 from C200 for a VLIW architecture.

FIG. 4 shows a VLIW processor having pipelines.

### DETAILED DESCRIPTION

Some units in the figures have the same number but are additionally labeled with a or b. If the number is used to reference without an additional a or b, then one of the existing units is intended but not a special instance. If only a particular instance of a unit is referenced, the identifier a or b is always put after the number.

In the following, an execution unit may denote both a processor/core/CPU, as well as an FPU (floating point unit), a DSP (digital signal processor), a co-processor or an ALU (arithmetic logical unit).

A processor core is made up, on the one hand, of memory elements (e.g. cache memories, registers) and of logic elements (e.g. the arithmetic logic unit (ALU)). Since memory elements having check codes (parity or ECC) may be monitored effectively, an additional monitoring attempts is simply doubling the logic of a core. In one specific embodiment, the structure of the logic of a core is a pipeline. For the present description, this pipeline is made up on its part of partial execution units (pipeline stages) which process instructions step-by-step. Control registers for controlling a processing logic and the controlled processing logic itself are combined to one pipeline stage. One of these pipeline stages is called an EXECUTE unit, and it executes the actual arithmetic/logical operation of the instruction. If the pipeline of an execution unit is doubled, and if the instructions of the program segment that is to be executed are passed on to both pipelines, the results at the outputs at the so-called EXECUTE unit are compared.

By contrast, in the case of processor cores, a doubling of partial stages of the pipeline is used to increase performance. To do this, two consecutive program instructions are executed simultaneously on one pipeline each, taking into account mutual dependencies. In this case, one speaks of a superscalar microprocessor.

How the pipelines are supplied simultaneously with instructions, in order to execute them in parallel, depends on the respective architecture. One possibility is to combine the instructions for the pipeline, that are executed in parallel, into a large instruction word. In this case, one speaks of a VLIW (very large instruction word) architecture. A further possibility is that the execution unit loads consecutive instructions from the memory and distributes them to the available pipelines, taking into account the dependencies.

A broadening of this system is the introduction of a switchover unit which, depending on the purpose of the application, switches the system into compare mode or performance mode. In the compare mode, the output signals of the execution units and the output signals of the EXECUTE stages of the pipeline are compared to one another. If there is a difference, an error signal will be output. In the performance mode, the two execution units work as a symmetrical multiprocessor system (SMP) or the pipelines of a superscalar microprocessor execute different instructions. In this mode, the comparator unit is not active. This extension is based on the assumption that not all program segments are critical with regard to safety and that for these the existing components may be used, not for error detection, but for performance enhancement.

Software-controlled switchover operations between these modes may be dynamically carried out during operation.

In the present invention described here, an execution unit is used that has two or more EXECUTE units and one comparator unit. The comparator unit is activated in that an instruction is identically coded in the memory several times consecutively. The two instruction words are executed in parallel by being distributed by the execution unit to different pipelines, and their results are compared. If the execution unit has a VLIW architecture, the comparator unit is activated because several identical partial instructions exist in one instruction word. If the instructions have been executed by the EXECUTE stage of the pipeline, the output signals of the stages are compared to one another. If a comparison of the output signals of the EXECUTE stages takes place, this is comparable to the compare mode of the architectures described in the related art. If no comparison takes place, and the two pipelines are processing different instructions (or partial instructions), this is comparable to the performance mode of the architectures described in the related art.

The present description shows two specific embodiments of the invention.

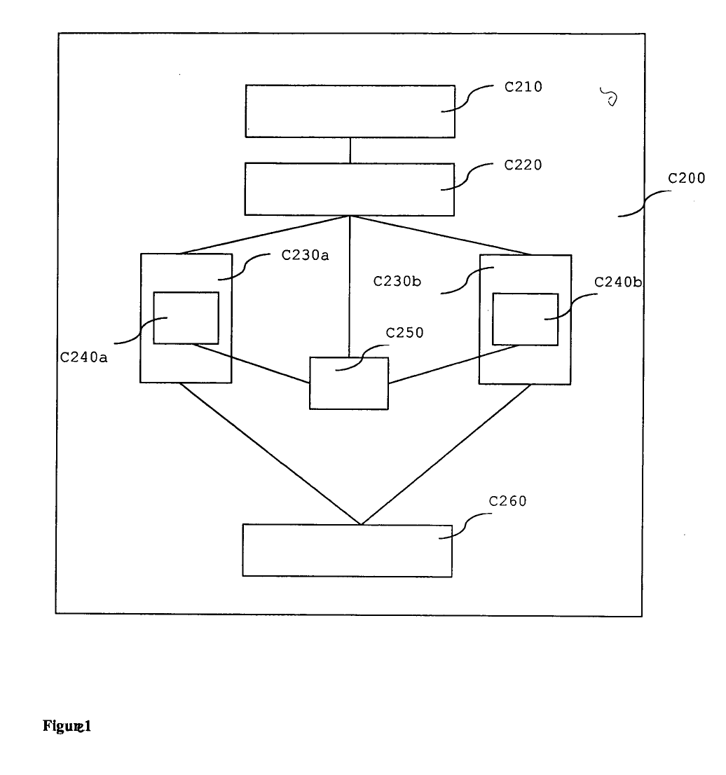

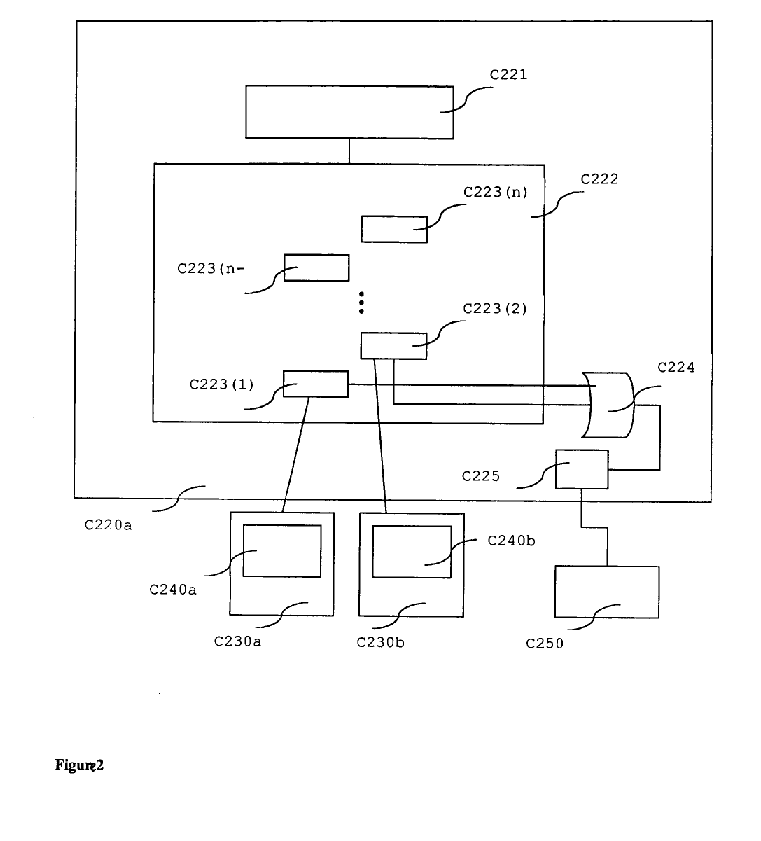

FIG. 1 shows schematically a possible layout of an execution unit C200 which has two pipelines C230a, C230b. Unit C210 loads the instruction words and routes them to decoding unit C220. At this stage the instructions are decoded and are buffered-stored in a queue (see FIG. 2 C220a) for further processing. The buffered instructions are taken from this queue and distributed to the two pipelines C230a and C230b. Within the pipelines there is in each case an EXECUTE stage C240a and C240b. These stages carry out the actual arithmetic or logical operation of an instruction. The results from stages C240a and C240b are brought together in C260, sorted according to the execution semantics on which unit C200 is based, and stored. Besides units C240a and C240b, pipelines C230a and C230b may be subdivided into further processing units (stages). The output signals of units C240a and C240b may be compared to one another by unit C250. Unit C250 generates an error signal if the output signals of C240a and C240b differ from one another. In order that the comparison in C250 is carried out only for the results of instructions that are identical, it is necessary that C220 activates comparator unit C250 only if two identical instructions are present. The deactivation may be implemented in different ways. For this purpose, a comparison by unit C250 is not carried out in that the unit itself is inactive, or is switched to be inactive by suitable signals. Furthermore, the inactivity may be achieved in that no signals are applied for comparison at unit C250. In one additional possibility, a comparison by unit C250 does take place, but the result is ignored.

If there is no VLIW architecture, unit C220a, shown in FIG. 2, describes in more detail a possible implementation of unit C220. Instructions that have been decoded by unit C221 are buffered-stored in a queue C222. This queue is implemented in the form of FIFO (first in, first out), so that instructions are passed on to the further pipeline stages in the sequence in which they were entered into the queue. C223(1) and C223(2) denote, at a given point, the two instructions which have to be passed on to subsequent pipelines C230a, C230b. If unit C220a discovers, via comparator unit C224, that two identical instructions C223(1) and C223(2) follow each other in queue C222, the two instructions are passed on simultaneously to respective pipeline C230a and C230b, and compare unit C250 is activated for the clock pulse at which the result is present at outputs C240a and C240b. Unit C225 ensures that the comparator unit is activated at the correct clock pulse. If instruction C223(1) has been executed by C240a and instruction C223(2) has been executed by C240b, the outputs of C240a and C240b are compared to each other by C250. In order to keep the hardware expenditure for detecting equal instructions or data as low as possible, it should be ensured that they directly follow each other as a pair, and that the first part of this pair is always at an odd position if the elements from the odd position are always processed in C230a and if the elements from the even position are always processed in C230b. This placement may be solved by default settings to the compiler.

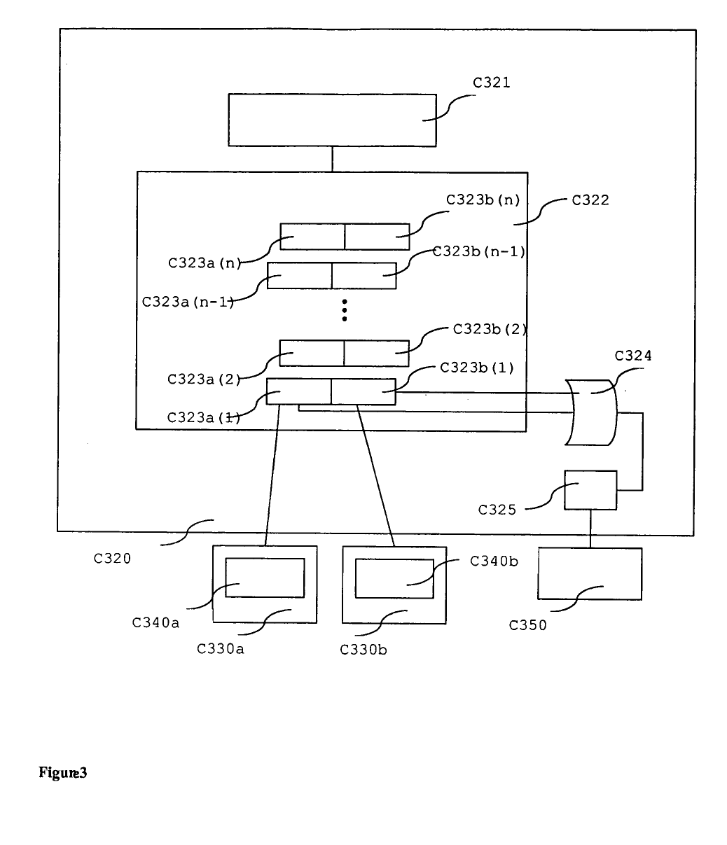

If there is a VLIW architecture present, unit C230, shown in FIG. 3, describes an additional specific embodiment of unit C220 of the present invention. In this instance, two partial instructions form an instruction word. In the case of a VLIW architecture, the decoded instructions are also stored in a queue C322, in the form of FIFO. In this case, unit C320 does not have to check for two identical, consecutive instructions in the queue via unit C324, but rather, whether two identical partial instructions C323a(1) and C323b(1) exist in one instruction word. If this is the case, comparator unit C350 is activated via C324 for the clock pulse at which the result is present at outputs of the EXECUTE stages C340a and C340b Unit C325 ensures that the comparator unit is activated at the correct clock pulse. Independently of whether the two partial instructions are identical or not, the two partial instructions C323a(1) and C323b(1) are distributed by unit C320 to the two pipeline stages C330a and C330b and are calculated there in parallel.

It may be flexibly established via this mechanism whether the result of an instruction is to be compared or not, without certain instructions or instruction sequences having to be reserved for a switchover. Whether a comparison takes place or not does not depend on any mode of the execution unit.

The invention described here may also be used for execution units having o (o>2) pipelines. When m(p<=o) identical instructions or identical partial instructions occur in one instruction word, situated one after another in the program run, the result is compared analogously to the method described above. In this context, depending on the implementation, the m may be fixed or also variable during the program run. Voting may be undertaken instead of the comparison. Units C224, C250 and C324, C350 for a VLIW processor then have to be adjusted to this larger number of pipelines. Appropriately adjusted units are then with a corresponding number of inputs for the comparison of the instructions/partial instructions and the output signals of the individual EXECUTE stages.

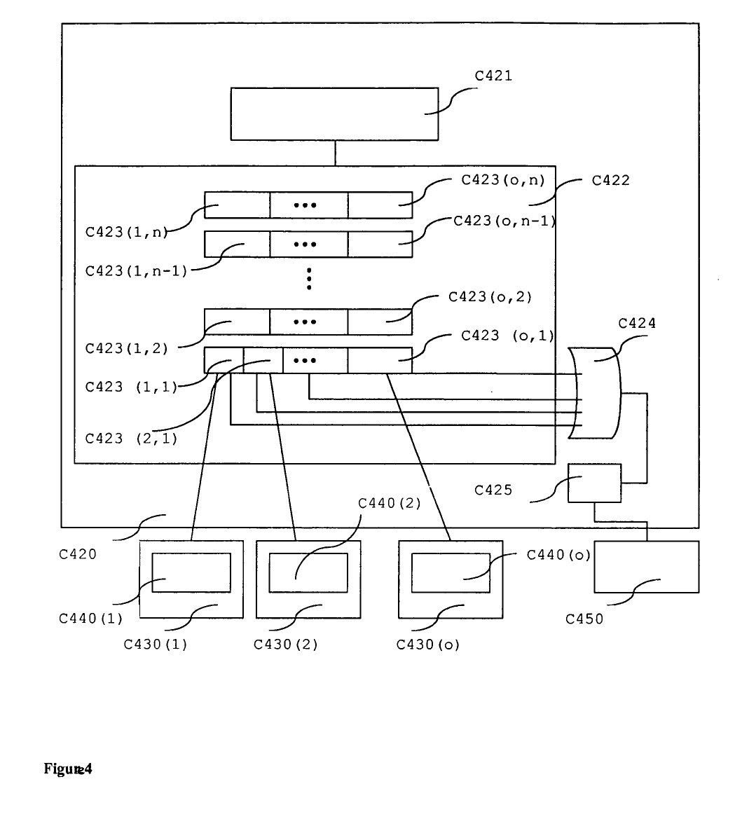

For a VLIW processor having o pipelines (o>2), an exemplary implementation is shown in FIG. 4. Thus, unit C420, shown in FIG. 4, describes an alternatively possible implementation of unit C220 of the present invention. In this case o partial instructions form an instruction word which, coded by C421, is stored in a queue C422 in the form of FIFO for enqueueing at the same width in each case of the o partial instructions. If o partial instructions exist and n enqueueings in the queue, then C423(a,b) denotes the a^{th} decoded partial instruction at the b^{th} position in the queue (a=1 . . . o and b=1 . . . n). Unit C420 checks whether there are p identical partial instructions C423(a,1 (a=1 . . . 0) in one instruction word. If this is the case, comparator unit C450 is activated via C424 for the clock pulse at which the result is present at outputs of the corresponding EXECUTE stages for the identical partial instructions. Unit C425 ensures that the comparator unit is activated at the correct clock pulse. Independently of whether the p partial instructions are identical or not, the n partial instructions C423(1,1) to C423(o,1) are distributed by unit C420 to the two pipeline stages C430(1) and C430(o), and are calculated there in parallel. In this case, C430(a) denotes the a^{th} pipeline that processes the a^{th} partial instructions.

In the parallel processing of data and instructions in two or more execution units, it may be advantageous not to let these execution units work with clock accuracy, but to operate them at a fixed clock pulse offset with respect to each other. This clock pulse offset may possibly be 0, 1, 2, 3, . . . , clock pulses, and may advantageously be delayed by an additional half clock pulse in each case. This has the advantage, especially in the manner of operation in compare mode, that globally acting error influences of a short duration are not able to act at the same time on the various execution units and the results generated thereby.

1-8. (canceled)

9. A method for processing data words and/or instructions, comprising:
making a distinction, in the processing, between at least two operating modes, including a first operating mode corresponding to a compare mode and a second operating mode corresponding to a performance mode;
in the compare mode, activating a comparator unit dependent on that at least two equal data words and/or instructions are processed and the at least two equal data words and/or instructions in each case are distributed by a control unit to at least two execution units; and
in the performance mode, deactivating the comparator unit.

10. The method according to claim 9, wherein the data words and/or the instructions are processed synchronously or at a fixed clock pulse offset.

11. The method according to claim 9, wherein the data words and/or the instructions are included in an instruction word as partial data words and/or partial instructions.

12. The method according to claim 9, wherein the data words and/or instructions are situated one after the other in a program run.

13. The method according to claim 9, wherein, depending on a number of equal consecutive data words and/or instructions, the number is distributed to a corresponding number of execution units.

14. The method according to claim 10, wherein the comparator unit is deactivated if two consecutive data words and/or instructions, which would be executed in the at least two execution units simultaneously or at the fixed clock pulse offset with respect to each other, are not consistent.

15. The method according to claim 9, wherein data and instructions that are to be compared are specified by a specifiable position in a memory.

16. A device for processing data words and/or instructions, a distinction being made, in the processing, between at least two operating modes, including a first operating mode corresponding to a compare mode and a second operating mode corresponding to a performance mode, the device comprising:
a comparator unit which is activated in the compare mode and deactivated in the performance mode; and
means for activating the comparator unit in the compare mode, dependent on that at least two equal data words and/or instructions are processed one after the other and the at least two equal data words and/or instructions in each case are distributed to at least two execution units.
